(19) United States
(12) Patent Application Publication
(10) Pub. No.: US 2010/0030943 A1
(43) Pub. Date: Feb. 4, 2010

(54) Semiconductor Memory

(76) Inventors: Kengo Maeda, Kitakatsuragi-gun (JP); Akira Tanigawa, Kyotanabe-shi (JP); Masuji Nishiyama, Habikino-shi (JP); Shoichi Ohori, Nara-shi (JP); Makoto Hirano, Amagasaki-shi (JP); Hiroshi Takashima, Kyoto-shi (JP); Shinji Matoba, Ikoma-shi (JP); Masamichi Asano, Kyoto-shi (JP)

Correspondence Address: MORRISON & FOERSTER LLP, 755 PAGE MILL RD, PALO ALTO, CA, 94304-1018, US

(21) Appl. No.: 10/589,375

(22) PCT Filed: Feb. 9, 2005
(86) PCT No.: PCT/JP2005/001893

§ 371 Date: Sep. 27, 2007

(30) Foreign Application Priority Data
Feb. 13, 2004 (JP) 2004-037293

(51) Int. Cl. G06F 12/00

(52) U.S. Cl. 711/103; 711/E12.001

(57) ABSTRACT

A semiconductor memory having a burst mode reading function in synchronization with a clock signal comprises a memory array composed of a plurality of memory cells, a sync read control circuit for releasing an upper group of the received address as a memory access address and a lower group of the received address as a burst address in synchronization with the clock signal, a sense amplifier for releasing an output data from each of the memory cells selected by the memory address, a decoder for decoding the burst address, a address latch for latching the decoded burst address in synchronization with the clock signal, a page selector for holding the output data and selecting corresponding one of the output data determined by the burst address of the address latch, and an output latch for latching the output data in synchronization with the clock signal.

### CROSS-REFERENCE TO RELATED APPLICATIONS

This application is a National Phase filing under 35 U.S.C. § 371 of International Application No. PCT/JP2005/001893 filed on Feb. 9, 2005, and which claims priority to Japanese Patent Application No. 2004-037293 filed on Feb. 13, 2004.

### TECHNICAL FIELD

The present invention relates to a semiconductor storage device for storing data with their addresses and particularly, a semiconductor memory having a function of reading out desired data in the burst mode.

### BACKGROUND ART

Flash memories, a type of semiconductor memories, are provided having a rewritable function for electrical rewriting and a nonvolatile property where stored data remains not erased when it is disconnected from the power supply, thus requiring no battery cells for storage of the data and now used widely as storage device in small mobile devices (in particular, mobile telephones).

As the third generation service for mobile telephones has been introduced some time ago, its application softwares are diversified including the Java (a tradename) application programs and other motion picture processing sequences and further demanded for improving the mass storage, the high-speed action, and the low power consumption of its built-in memories.

One type of flash memories employs a synchronous burst read mode (referred to as sync read hereinafter) for reading data from memory cells at higher speeds.

The sync read is based on synchronization with an external clock signal for continuously reading data from the memory cells and thus higher in the data read speed than other known reading techniques including the asynchronous random read mode and the asynchronous page read mode (See Patent Document 1).

Patent Document 1: Japanese Patent Laid-open Publication No. 2001-176277

### DISCLOSURE OF INVENTION

### Problems to be Solved by the Invention

Generally in the sync read, a set of address (for example, A0 to A22) received from the outside is latched by an address latch 1 before transferred to a sync read control circuit (address counter) 20 as shown in FIG. 4.

Then, upon receiving a chip enable signal CE for activating the flash memory, an input buffer generates an internal clock signal K from the external clock signal. The internal clock signal K is used for synchronizing the internal actions. The internal clock signal K is identical in the frequency to the external clock signal but different in the phase.

When the input buffer receives an address valid signal ADV, it becomes ready to receive the address from the outside.

With the effective edge (for example, the fall edge) of either the address valid signal ADV or the chip enable signal CE which comes later, the sync read start clock signal is generated. At the timing of the edge (for example, the rise edge) of the sync read start clock signal, the address is drawn in. In response, when the sync read mode has been preset, the burst read action starts from the edge (for example, the rise edge) of the initial internal clock signal K.

More specifically, when the address valid signal ADV and the chip enable signal CE have received and the read action is set with the sync read mode, the sync read start clock signal is generated and transferred by the internal circuit to the sync read control circuit (address counter) 20 which in turn starts the burst read action.

Accordingly, the sync read control circuit 20 feeds a memory array 4 with a memory access address R3.

As the memory access address received is decoded by a decoder 4A, a plurality of memory cells are selected in pages (for example, 128 bits per page) from the memory array 4 and data saved in the selected memory cells are read out and transferred to a sense amplifier circuit (S/A) 4B.

The sense amplifier circuit 4B examines the data read out from the memory cells (after the data at a lower level are amplified). The data are latched and transferred as a memory data R5 to a page selector 5. The description will be made assuming that the page holds 128 bits and one word consists of 16 bits.

In response to the burst address from the sync read control circuit 20, the page selector 5 sequentially selectively picks up each word from the memory data R5 and delivers the same as an output data to an output latch 6.

The memory address corresponds to an upper group of the received address for selecting the memory cells in the pages while the burst address correspond to a lower group of the received address for selecting the memory cells in the words from those in the pages.

The sync read control circuit 20 delivers as the burst address R4 the lower group of the address received from the address latch 1 at the initial state, as shown in FIG. 4.

Upon being timed with the internal clock signal, the sync read control circuit 20 increments the lower group of the address (by one) and sequentially delivers its increment as the burst address.

There is hence needed an access time (asynchronous period) extending from the delivery of the memory address R11 from the sync read control circuit 20 to the output of a data from the sense amplifier circuit 4B.

This allows the access time to be defined by a number of clock pulses for the sync read control circuit 20 examining the timing of the internal clock signal for delivering the burst address.

Assuming that the access time is 60 ns and the operation frequency of the internal clock signal is 100 MHz (10 ns), the sense amplifier circuit 4B delivers the memory data after the access time of six internal clock pulses.

In the conventional circuit shown in FIG. 4, a data at the accessed address is sequentially read in the burst mode out of the output buffer in synchronization with the internal clock from the seventh clock pulse after six pulses of the internal clock signal have elapsed since the memory access address is released by the sync read control circuit 20.

Simultaneously, the sync read control circuit 20 starts incrementing the burst address as timed with the seventh pulse of the internal clock signal.

This allows the page selector 5 to selectively pick up and deliver one word (16 bits), which corresponds to the burst address, from eight words (128 bits) of the memory data read out from the memory array, determined by the burst address decoded by a decoder 3.

Upon being timed with the internal clock signal, an output latch 6 latches and releases the data Dn of one word.

As understood from FIG. 4, the sync read control circuit 20 in the prior art when being timed with the internal clock signal allows its action from the output of the burst address to the output latch 6 latching the memory data read out from the memory array 4 to be executed within one cycle of the internal clock signal.

More particularly, as apparent from the timing chart of FIG. 5 showing an action of a conventional chip circuit, the main data R8 released from the page selector 5 has to be determined before the timing of setting up the output of the output latch 6 at the rise of the internal clock signal K.

However, as the internal clock signal K is increased in the frequency for speeding up the reading action, its cycle may fail to be longer than the duration of transmission of the signal along the transmission path before the memory data R8 from the page selector 5 becomes stable when the burst address R4 has been incremented and transferred via the decoder 3 to the page selector 5 after the internal clock signal K was received by the sync read control circuit 20, whereby the access time at the sync read mode will substantially be limited.

Assuming that, for example, the duration from the rise of the internal clock signal K to the output of the burst address R4 is 5 ns, the delay time when the memory data R5 is selected by a data hold signal R7 and released as the main data R8 from the page selector 5 with a delay of 2 ns in the decoder 3 is 2.5 ns, and the setup time of the output latch 6 is about 1 ns, the setting time (the transmission time) required for the output latch 6 correctly latching the data after the internal clock signal K is received by the sync read control circuit 20 is expressed by:

5 ns+2 ns+2.5 ns+1 ns=10.5 ns.

It is then concluded that, when the cycle of the internal clock signal K remains not greater than 11 ns (90 MHz at the frequency), the circuitry arrangement of the prior art can handle the action.

In the timing chart shown in FIG. 5, the frequency of the internal clock signal K is 50 MHz while the retrieval of data by the external circuit starts from the seventh clock pulse of the internal clock signal K. As the memory access address R3 has been received, a series of data D0, D1, D2, D3 . . . are released word by word after the seventh pulse.

However, when the cycle of the internal clock signal K is 7.5 ns (at a frequency of 133 MHz) as shown in FIG. 6, it will be shorter than the above setting. Accordingly, while the data D0 is successfully released at the timing of the seventh clock pulse with the burst address R4 incremented, the new data hold signal R7 is not received when the output latch 6 receives the eighth clock pulse and the output of the page selector 5 fails to shift from D0 to D1.

This allows the output to be kept at D0 at the timing of the eighth pulse of the internal clock signal K and then released as D1, D2, D3 . . . in a sequence after the ninth clock pulse.

As described in the conventional manner, in response to the burst address R4 received from the sync read control circuit 20, the memory data R5 from the memory array 4 has to be released from the page selector 5 within one cycle of the internal clock signal K and then dispatched as an output data from the output latch 6 at the timing of the succeeding internal clock pulse.

However, since the speed up at the transmission path is limited by the setting time, the frequency of the internal clock signal K will no more be increased. This varies the timing of the output of data depending on the frequency of the internal clock signal K, thus failing to follow the speed up of the access time.

Also, for ensuring the speed up in the conventional manner, there is only a costly technique of improving the performance of a MOS transistor or minimizing the chip size.

The improvement of the MOS transistor performance requires significant increase in the labor, the time, and the cost and will be unfavorable for speeding up the data read action.

Also, the minimizing the chip size requires downsizing of its process and will hence increase the facility investment and the overall production cost. While the chip is increased in the price, its manufacturing process will hardly be downsized in the today's technologies. Therefore, the minimizing the chip size for speeding up the action will be impractical.

The present invention has been developed in view of the above aspects and its object is to provide a semiconductor memory which can increase the action speed at the synchronous burst read mode without improving the performance of transistors.

### Means for Solving the Problem

A semiconductor memory according to the present invention is provided which is a semiconductor memory having a burst mode reading function of continuously reading data in synchronization with a clock signal. The semiconductor memory comprises a memory array composed of a plurality of memory cells, a sync read control circuit for releasing an upper group of the received address as a memory access address in synchronization with the clock signal and for sequentially modifying and releasing as a burst address the remaining of the received address excluding the upper group in synchronization with the clock signal, a sense amplifier for amplifying a small output signal received from each of the memory cells selectively determined by the memory address and releasing the amplified signal as an output data, a decoder for decoding the burst address, a burst latch for latching and releasing the decoded burst address in synchronization with the clock signal, and a page selector for holding the output data and selecting corresponding one of the output data determined by the burst address.

Another semiconductor memory according to the present invention is provided which is a semiconductor memory having a burst mode reading function of continuously reading data in synchronization with a clock signal. The another semiconductor memory comprises a memory array composed of a plurality of memory cells, a sync read control circuit for releasing an upper group of the received address as a memory access address in synchronization with the clock signal and for sequentially modifying and releasing as a burst address the remaining of the received address excluding the upper group in synchronization with the clock signal, a sense amplifier for amplifying a small output signal received from each of the memory cells selectively determined by the memory address and releasing the amplified signal as an output data, a decoder for decoding the burst address, a burst latch for latching and releasing the decoded burst address in synchronization with the clock signal, a page selector for holding the output data and selecting corresponding one of the output data determined by the burst address, and an output latch for latching and releasing the output data selected by the page selector in synchronization with the clock signal.

Each of the semiconductor memories according to the present invention may be modified in which the sync read control circuit is arranged to increment the burst address in synchronization with the clock signal as starting from the timing of the (N-1)th clock pulse where N being the predetermined number of clock pulses of the clock signal as defined between the release of a burst mode start signal and the output of the output data.

A further semiconductor memory according to the present invention is provided which is a semiconductor memory having a burst mode reading function of continuously reading data in synchronization with a clock signal. The further semiconductor memory comprises a memory array composed of a plurality of memory cells, a sync read control circuit for releasing an upper group of the received address as a memory access address in synchronization with the clock signal and for sequentially modifying and releasing as a burst address the remaining of the received address excluding the upper group in synchronization with the clock signal, a sense amplifier for amplifying a small output signal received from each of the memory cells selectively determined by the memory address and releasing the amplified signal as an output data, a decoder for decoding the burst address, a burst latch for latching and releasing the decoded burst address in synchronization with the clock signal, a page selector for holding the output data and selecting corresponding one of the output data determined by the burst address, and an output latch for latching and releasing the output data selected by the page selector in synchronization with the clock signal, wherein the burst latch and the decoder are arranged to develop a composite circuit with the burst latch being a flip-flop comprising a master circuit and a slave circuit, the master circuit connected at an upstream side of the decoder and the slave circuit connected at a downstream side of the decoder.

The further semiconductor memory according to the present invention may be modified in which the sync read control circuit is arranged to increment the burst address in synchronization with the clock signal as starting from the timing of the (N-1)th clock pulse where N being the predetermined number of clock pulses of the clock signal as defined between the release of a burst mode start signal and the output of the output data.

The further semiconductor memory according to the present invention may be modified in which the composite circuit is arranged in which the burst address latched by the master circuit is decoded by the decoder and then latched by the slave circuit.

The further semiconductor memory according to the present invention may be modified in which the composite circuit has an output address switching function for releasing the burst address when it is at the burst read mode and directly releasing the lower group of the address when it is at the asynchronous read mode.

An address control circuit according to the present invention is provided which is an address control circuit provided in a semiconductor memory. The address control circuit is constructed as a composite circuit having a master circuit of a flip-flop connected at an upstream side of a decoder and a slave circuit of the flip-flop connected at a downstream side of the decoder, which is arranged responsive to a read switching signal, a clock signal, a synchronous address signal synchronized with the clock signal, and an asynchronous address signal received from the outside, and when the read switching signal is at the synchronous read mode, the composite circuit selects the synchronous address signal, latches the synchronous address signal with the clock signal in the master circuit of the flip-flop, decodes the latched synchronous address signal with the decoder, and latches the decoded synchronous address signal with the clock signal in the slave circuit of the flip-flop, and alternatively when the read switching signal is at the asynchronous read mode, the flip-flop becomes conductive and the decoder decodes and releases the asynchronous address signal.

The address control circuit according to the present invention may be modified in which the composite circuit is arranged for decoding the synchronous address signal latched by the master circuit with the decoder and latching the decoded synchronous address signal with the slave circuit.

The address control circuit according to the present invention may be modified in which the composite circuit has an output address switching function of releasing the synchronous address signal when it is at the synchronous read mode and directly releasing the asynchronous address signal when it is at the asynchronous read mode.

### Effect of the Invention

As described, the present invention is designed for a burst output of the output data within the predetermined number of clock pulses to control the clock pulses with a latch so that the burst address is modified at the timing preceded by one clock pulse from the original burst address modifying timing to correspond to the number of the clock pulses for the output data.

More specifically, the preset invention allows the burst address to be incremented at the timing of the (N-1)th clock pulse where N is the number of clock pulses predetermined for the data (N being an integer and N>M where M (an integer) being the number of clock pulses in the access time for a memory array).

In the sync read mode, the number of clock pulses in a period between the synchronous start clock edge and the output of the output data (including the access time for the memory array) is predetermined.

Accordingly, the delay in the page selector and the decoder according to the present invention can be independently separated from the delay from the page selector to the output latch. As the delay is isolated, the action margin will increase thus allowing the clock frequency to be increased for speeding up the action of data transmission.

As set froth above, the semiconductor memory according to the present invention can increase the clock frequency for the burst output at the sync read mode without improving the performance of transistors, thus shortening the access time for the high-speed action.

### BRIEF DESCRIPTION OF DRAWINGS

FIG. 1 is a block diagram of a flash memory arrangement showing the first or second embodiment of the present invention;

FIG. 2 is a timing chart showing an example of the action of the flash memory shown in FIG. 1;

FIG. 3 is a block diagram of a latch/decode circuit arrangement in the second embodiment of the present invention;

FIG. 4 is a block diagram showing an arrangement of a conventional flash memory;

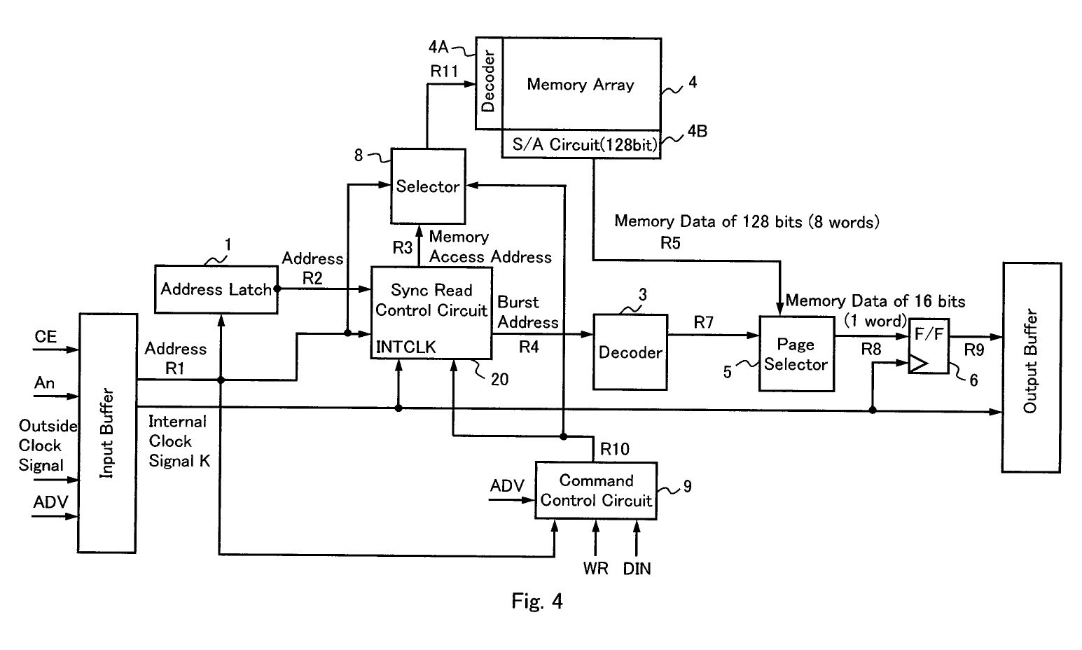

FIG. 5 is a timing chart showing an example of the action of the conventional flash memory shown in FIG. 4; and

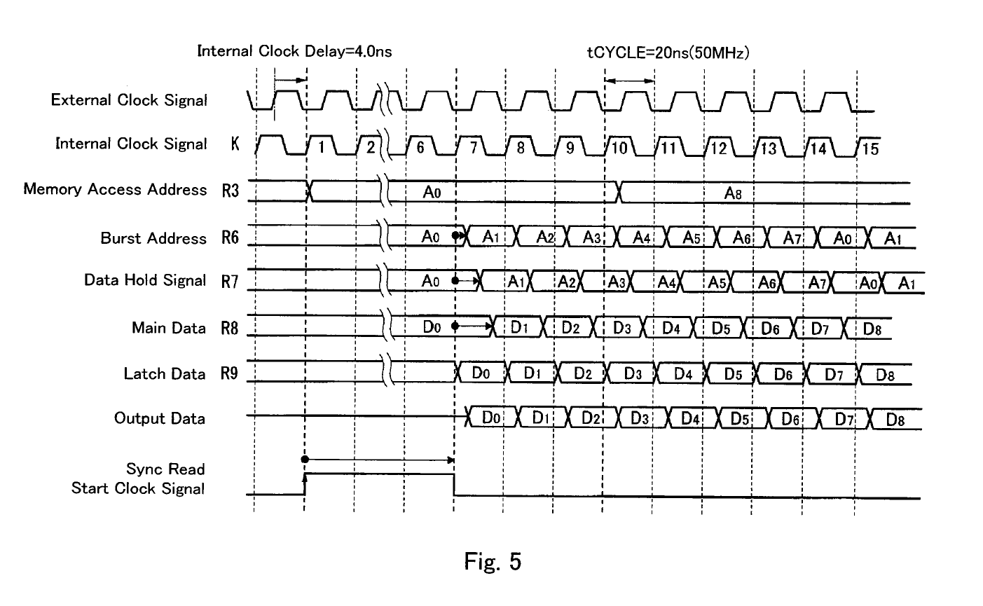

FIG. 6 is a timing chart showing another example of the action of the conventional flash memory shown in FIG. 4.

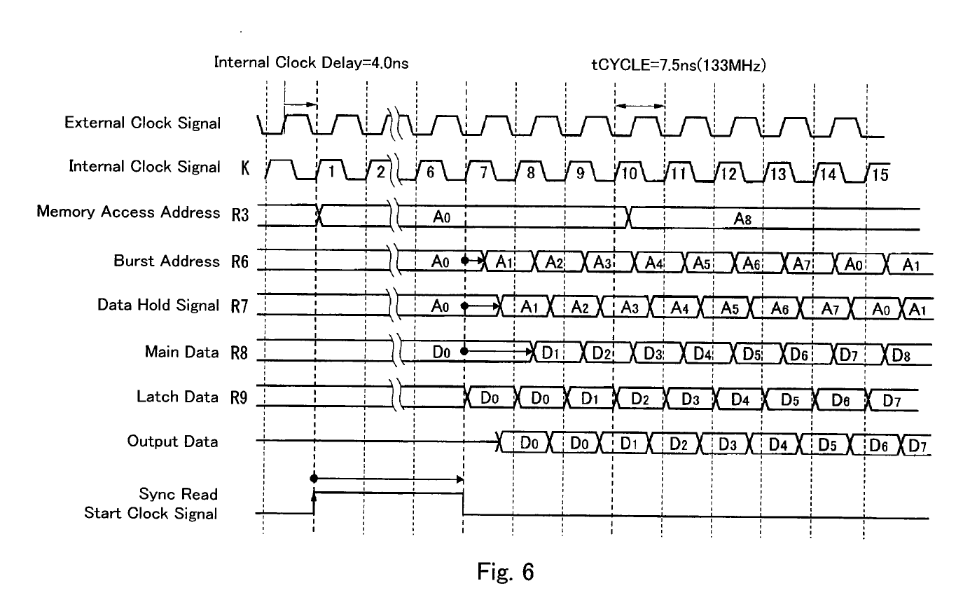

### EXPLANATION OF REFERENCES

### 1: Address Latch

### 2, 20: Sync Read Control Circuit

### 3, 4A: Decoder

### 4: Memory Array

### 4B: Sense Amplifier Circuit

### 5: Page Selector

### 6: Output Latch

### 7: Latch

### 8: Selector

### 9: Command Control Circuit

### 11, 12, 13, 14, 15, 16, 17, 18: Switch

### BEST MODE FOR CARRYING OUT THE INVENTION

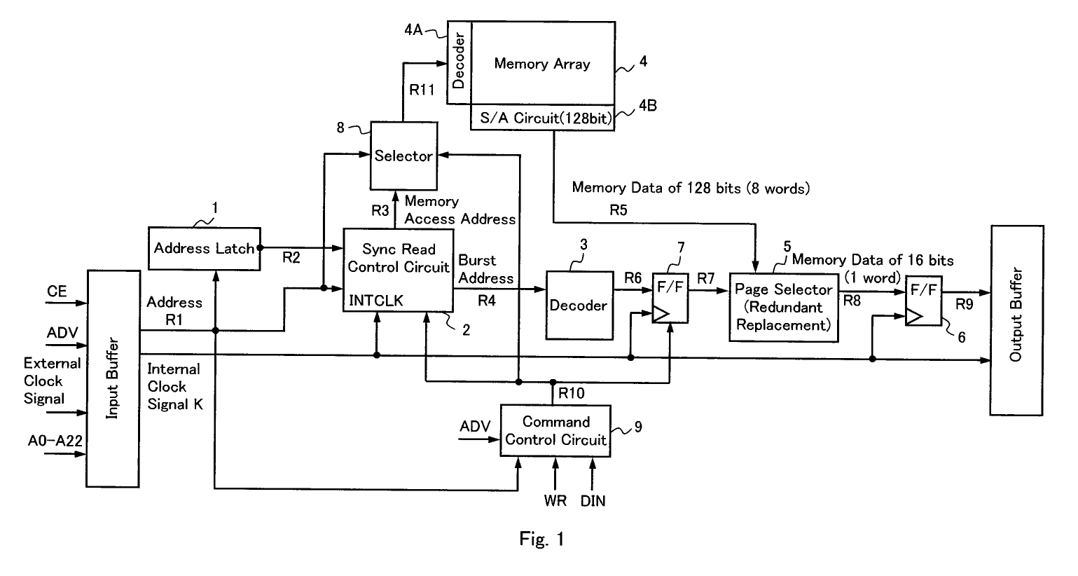

According to the present invention, for carrying out the sync read action among a plurality of read action modes of a semiconductor memory, a latch 7 for adjustment of the timing is connected between a sync read control circuit 2 and an output latch 6 as shown in FIG. 1. This allows the burst address R4 to start being incremented by the internal clock signal K at the timing of one cycle before a duration determined by the predetermined number of clock pulses has elapsed while the start of incrementing the burst address in the sync read control circuit 2 in the prior art is timed with the end of the number of clock pulses between the start of the sync read action and the output of a data.

More specifically, the sync read control circuit 2 modifies the burst address R4 at the timing earlier by one clock pulse than the predetermined clock cycle (the minimum being a sum of the number of clock pulses in the access time and one cycle of the internal clock signal) of the internal clock signal K from the input of the sync read start clock edge to the output of the output data.

Assuming that the cycle of the internal clock signal is N, a data D0 is delivered at the timing of the Nth pulse of the internal clock signal K and its succeeding data D1 at the timing of the (N+1)th pulse of the same.

In the prior art, the burst address starts being incremented at the Nth pulse of the internal clock signal in the sync read control circuit 20. The sync read control circuit 20 in the present invention starts the increment of the burst address at the (N-1)th pulse of the internal clock signal K.

Accordingly, since the output timing is controlled with the latch 7 holding one pulse of the internal clock signal through dividing the delay time extending from the sync read control circuit 2 receiving the internal clock signal K to a page selector 5 releasing the burst address incremented, i.e., preceding the timing for starting the modification of the burst address in the sync read control circuit 2 by one pulse of the internal clock signal from the timing of the prior art, the timing of the burst address received by the output latch 6 is equal to the action with the number of clock pulses in the prior art.

In other words, while the burst address to be modified takes two pulses of the internal clock signal before arriving at the output latch 6, one of the two pulses is for the output delay of a decoder 3 and the other is for the action of the page selector 5 and the output latch 6. This allows the delay time to have a margin along a path through which the burst address is transmitted, hence eliminating the problem of delay.

As understood, the present invention is intended to speed up the internal action in view of the demand for increasing the speed of address and data along the transmission path in a chip to match the today's high-speed action of a clock signal received from the outside.

### First Embodiment

The sync read is provided in which in response to reception of the address signal An (expressed by a integer of 1≦n≦22 in this embodiment) for a start address from which a memory data is read out by the action of an input buffer with the sync read mode being set for the reading action, the command as a data DIN for starting the sync read mode, and the sync read start clock edge, the address for reading a corresponding data from the memory array 4 is automatically incremented as being timed by the internal clock signal for delivering the data of consecutive addresses in synchronization with the internal clock signal.

The first embodiment of the present invention will be described in more detail referring to FIG. 1. FIG. 1 illustrates an arrangement of a flash memory of the first embodiment. Like components are denoted by like numerals as those of the prior art and will be explained in no more detail.

The input buffer receives from outside a set of signals including the chip enable signal, the address signal An, the address valid signal ADV, the external clock signal, the data DIN signal, and the write signal WR via the pad and after their waveform adjustment, transfers them to the internal circuit. The input buffer also generates and delivers an internal clock signal K from the received external clock signal.

The address signal An for indicating a desired address, the write signal WR, the data DIN signal for commanding the action at the sync read mode, and the address valid signal ADV are received by a command control circuit 9 which acknowledges the sync read mode and dispatches a read switching signal R10.

Upon being timed with the internal clock signal K, an address latch 1 latches the address R1 (An) received from the input buffer.

The address R2 from the address latch 1 is then separated into a memory access address R3 (an upper group of the address, A3 to A22 for example) and a burst address R4 (a lower group of the address, AO to A2 for example) by the sync read control circuit 2 before the memory access address R3 is transferred to a selector 8.

Also, the sync read control circuit 2 has a selector function for designating the lower address as the start number of counts in an internal counter when the read switching signal R10 is indicative of the sync read mode and directly transferring the lower address received when the read switching signal R10 is indicative of an asynchronous read mode.

When the asynchronous read mode is demanded, the data DIN signal carrying a command for selecting the asynchronous read mode is received by the command control circuit 9 which in turn delivers the read switching signal R10 indicative of the asynchronous read mode.

The selector 8 switches whether either of the upper address received directly from the input buffer or the memory access address R3 received from the sync read control circuit 2 is fed to the decoder 4A.

The selector 8 dispatches the memory access address R3 when the read switching signal R10 is indicative of the sync read mode and the upper address received directly from the input buffer when the read switching signal R10 is indicative of the asynchronous read mode.

The latch 7 is provided for controlling the timing and more particularly, latching the burst address R6 decoded from the burst address R4 by the decoder 3 upon being timed with the internal clock signal K.

The page selector 5 receives a memory data R5 of 128 bits (8 words) from the start address which has been read from the memory array 4 and saved in the sense amplifier circuit 4B and, in response to a data hold signal R7 delivered from the latch 7 timed with the internal clock signal K, selectively dispatches one of the eight words in the data R5 as a memory data R8.

The output latch 6 transfers the memory data R8 received from the page selector 5 to an external circuit as a latch data R9 via the output buffer and the pad upon being timed with the internal clock signal K.

The output latch 6 and the latch 7 hold the data received at the timing of the rise of the internal clock signal K.

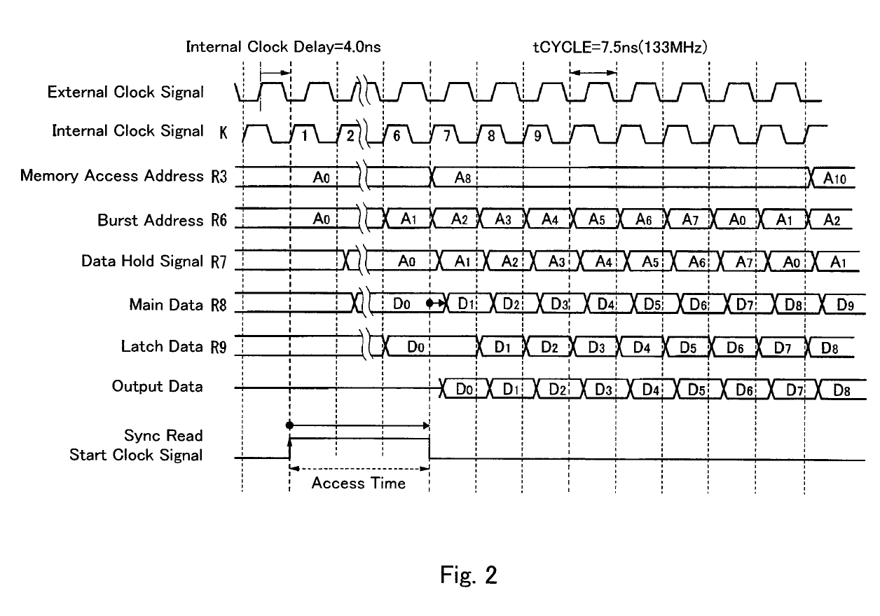

The sync read action of the flash memory of the first embodiment will now be described referring to FIG. 2. FIG. 2 is a timing chart showing a procedure of actions at the sync read mode. So far, the chip enable signal CE and the data DIN signal carrying a command for selecting the sync read mode have been received. It is assumed that the external clock signal for activating the flash memory has, for example, a frequency of 133 MHz and the data is continuously released from the seventh clock pulse after the input of the sync read start clock edge as is equal to the prior art. The numerals in the internal clock signal K shown in FIG. 2 represent the clock pulses generated after (the rise of) the sync read start clock signal.

The address signal An indicative of the sync read start address is then received from the external pad assigned with each address.

The address valid signal ADV is also received from the outside in a predetermined manner to start the sync read action.

At the time, the sync read start clock signal is generated by the given circuit in synchronization with the internal clock signal K and used for latching at the address latch 1 the address signal An indicative of the sync read start address.

The address latch 1 delivers an indefinite data when the address valid signal ADV is received at the H level. When the sync read start clock signal is shifted from the H level to the L level (as activated by negative logic), the address R1 received from the input buffer is latched and delivered as the address R2.

Simultaneously, the sync read start clock signal is held at the timing whichever comes earlier of the effective (rise) edge of the internal clock signal K after the address valid signal ADV shifting to the L level or of the shift of the address valid signal ADV from the L level to the H level. This allows the address latch 1 to latch the address R1 as an initial address upon being timed with the sync read start clocks signal.

This is followed by the sync read control circuit 2 dispatching the upper group of the address R2 received from the address latch 1 as the memory access address R3 to the selector 8.

Since the action is at the sync read mode, the selector 8 passes the memory access address R3 to the decoder 4B.

The decoder 4B decodes the memory access address R3 and selects the memory cells in the memory array 4 from which the corresponding data is read out.

The data read out from the memory cells is then transferred as the memory data R5 of 128 bits (8 words) to the page selector circuit 5 where it is held. (When the sync read control circuit 2 has automatically incremented the lower group of the initial address and allowed the page selector 5 to output all the data of a set of eight words, it dispatches the memory access address to the memory array 4 at the timing of the page selector 5 outputting another set of eight words.)

Because of the sync read mode, the sync read control circuit 2 sets its internal counter with the data of the lower group of the address R2 as the start number for counting.

After the action of accessing the memory array 4 is started by the sync read start clock signal, the sync read control circuit 2 starts the action of incrementing (modifying) the burst address R4 at the rise at the sixth cycle of the internal clock signal K which is equal to the timing earlier by one clock pulse than the timing when the predetermined access time has passed, that is, the sixth cycle of the internal clock signal K (from the sync read start clock signal) has elapsed.

More particularly, while the prior art starts the action of incrementing the burst address exactly at the timing of the number of clock pulses required for output of the data, the action of incrementing the burst address according to the present invention starts earlier by one clock pulse than the timing.

Accordingly at the rise of the sixth pulse of the internal clock signal K, the burst address R4 is shifted to determine the second word (D1) of eight words (D0 to D8) in the page selector 5. The latch 7 latches the data hold signal R7 indicative of the first word (D0), allowing the page selector 5 to deliver the data of the first word (D0).

Then, at the rise of the seventh pulse of the internal clock signal K, the burst address R4 is shifted to determine the third word (D2) of eight words (D0 to D8) in the page selector 5. The latch 7 latches the data hold signal R7 indicative of the second word (D1), allowing the page selector 5 to deliver the data of the second word (D1). The output latch 6 holding the data of the first word as the latch data R9, allowing the latch data R9 to dispatched as an output data from the output buffer via the pad.

This is followed by dispatching outputs of D1, D2, . . . in a sequence after the eighth clock pulse.

The foregoing circuitry arrangement of this embodiment permits the latch 7 to be inserted for controlling the number of clock pulses before the predetermined timing of the output for dispatching earlier by one clock pulse than the prior art and transmitting the burst address from the sync read control circuit 2 to the page selector 5 in two clock pulses as the shift of the burst address is preceded by one clock pulse while the transmission path of the burst address and its data from the sync read control circuit 2 to the output latch 6 is connected within one clock pulse in the prior art, whereby the delay in the transmission of the burst address which interrupts the improvement of the access time in the sync read action can be eliminated.

### Second Embodiment

A flash memory according to the second embodiment of the present invention will now be described. The second embodiment is differentiated from the first embodiment by the fact that the function of the read switching signal R10 switching the address output between the sync read mode and the asynchronous read mode by a combination of the decoder 3, the latch 7, and the sync read control circuit 2 is carried out by a single circuit. The sync read control circuit 2 in the second embodiment is hence arranged to have the function of the sync read control circuit 2 in the first embodiment excluding the function of switching the address output between the sync read mode and the asynchronous read mode. In this embodiment, the read mode switching signal is predetermined by a command (DIN) signal and delivered from a command control circuit 9.

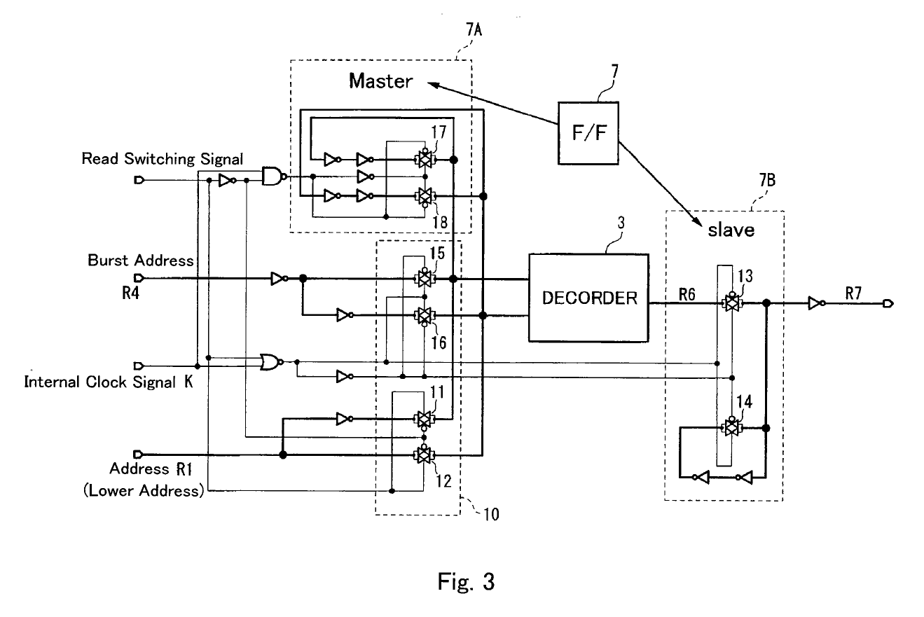

The decode/latch circuit (an address control circuit of a semiconductor memory) in the second embodiment for implementing the function of the read switching signal R10 switching the address output between the sync read mode and the asynchronous read mode by a combination of the decoder 3, the latch 7, and the sync read control circuit 2 will be described referring to FIG. 3. FIG. 3 is a block diagram of the decode/latch circuit arrangement showing the second embodiment.

The decode/latch circuit is arranged in which the latch 7 (which is actually not present in the circuit arrangement shown in FIG. 3 as denoted for the description) is divided into a master circuit 7A and a slave circuit 7B. The master circuit 7A and a selector 10 for switching the address output are located at the upstream side of a decoder 3 while the slave circuit 7B is located at the downstream side of the decoder 3.

When the read switching signal is indicative of the asynchronous read mode (for example, the read switching signal is at the H level), both switches 11 and 12 turn on to feed the decoder with the address R1. The address is then decoded and not latched but passed across a switch 13 which remains turned on.

At the time, other switches 14 and 15 to 18 all remain turned off and not conductive, thus allowing no processing of the burst address R4.

Alternatively, when the read switching signal is indicative of the sync read mode (for example, the read switching signal is at the L level), the switches 11 to 13 remain turned off and not conductive, thus allowing no processing of the address R1.

When the internal clock signal K is at the L level, the switches 15 and 16 turn on to feed the master circuit 7A with the burst address R4.

As the time, the switches 18 and 19 remain turned off thus allowing the master circuit 7A not to hold the address R4.

Also, the switch 13 in the slave circuit 7B remains turned off while the switch 14 is turned on, thus allowing the preceding data hold signal R7 to be held.

When the internal clock signal K is shifted to the H level, the switches 15 and 16 in the master circuit 7A are turned off while the switches 17 and 18 are turned on, thus allowing the burst address R4 to be held which has been received when the internal clock signal K was at the L level.

This allows the burst address R4 to be decoded by the decoder 3 and released as the burst address R6.

As the switch 13 is turned on and the switch 14 is turned off in the slave circuit 7B, the burst address R6 is directly transferred as the data hold signal R7.

When the internal clock signal K is shifted back to the L level, the switches 13 and 14 in the slave circuit 7B are turned off and on respectively, thus allowing the burst address R6 to be latched before released as the data hold signal R7.

As the result, the decode/latch circuit decodes the burst address R4 from one rise to the succeeding rise of the internal clock signal K, thus allowing the data hold signal R7 to be latched and released.

The other actions are identical to those of the first embodiment and will thus be explained in no more detail.

As described above, the second embodiment has a composite circuit composed of circuit blocks including the latch 7 and the decoder 3 and having the function of switching the address for speeding up the address path for asynchronous reading actions and minimizing the scale of circuitry arrangement, whereby the delay along the address transmission path can be further shortened than that of the first embodiment while the overall circuit arrangement remains not bulky.

Also, it is possible to reduce the adverse effect of inserting the latch 7 for controlling the clock timing at the sync read mode on the delay in the address transmission at the asynchronous read mode.

Although the semiconductor memory is a flash memory in each of the first and second embodiments, it may successfully be applied to any other memory device such as dynamic memory or mask ROM (read only memory) for conducting the burst reading action.

### INDUSTRIAL APPLICABILITY

The present invention is applicable to a semiconductor memory which has a function of reading desired data at the burst mode and favorably employed as a storage device in a small portable apparatus (such as a mobile telephone preferably).

1. A semiconductor memory having a burst mode reading function of continuously reading data in synchronization with a clock signal comprising:
a memory array composed of a plurality of memory cells;
a sync read control circuit for releasing an upper group of a received address as a memory access address in synchronization with the clock signal and for sequentially modifying and releasing as a burst address a remaining of the received address excluding the upper group in synchronization with the clock signal;
a sense amplifier for amplifying a small output signal received from each of the memory cells selectively determined by the memory address and releasing the amplified signal as an output data;
a decoder for decoding the burst address;
a burst latch for latching and releasing the decoded burst address in synchronization with the clock signal; and
a page selector for holding the output data and selecting corresponding one of the output data determined by the burst address.

2. A semiconductor memory having a burst mode reading function of continuously reading data in synchronization with a clock signal comprising:
a memory array composed of a plurality of memory cells;
a sync read control circuit for releasing an upper group of a received address as a memory access address in synchronization with the clock signal and for sequentially modifying and releasing as a burst address a remaining of the received address excluding the upper group in synchronization with the clock signal;
a sense amplifier for amplifying a small output signal received from each of the memory cells selectively determined by the memory address and releasing the amplified signal as an output data;
a decoder for decoding the burst address;
a burst latch for latching and releasing the decoded burst address in synchronization with the clock signal;
a page selector for holding the output data and selecting corresponding one of the output data determined by the burst address; and
an output latch for latching and releasing the output data selected by the page selector in synchronization with the clock signal.

3. The semiconductor memory according to claims 1 or 2, wherein the sync read control circuit is arranged to increment the burst address in synchronization with the clock signal starting from a timing of the (N-1)th clock pulse where N being a predetermined number of clock pulses of the clock signal between a release of a burst mode start signal and the output of the output data.

4. A semiconductor memory having a burst mode reading function of continuously reading data in synchronization with a clock signal comprising:
a memory array composed of a plurality of memory cells;
a sync read control circuit for releasing an upper group of a received address as a memory access address in synchronization with the clock signal and for sequentially modifying and releasing as a burst address a remaining of the received address excluding the upper group in synchronization with the clock signal;
a sense amplifier for amplifying a small output signal received from each of the memory cells selectively determined by the memory address and releasing the amplified signal as an output data;
a decoder for decoding the burst address;
a burst latch for latching and releasing the decoded burst address in synchronization with the clock signal;
a page selector for holding the output data and selecting corresponding one of the output data determined by the burst address; and
an output latch for latching and releasing the output data selected by the page selector in synchronization with the clock signal, wherein
the burst latch and the decoder are arranged to develop a composite circuit with the burst latch being a flip-flop comprising a master circuit and a slave circuit, the master circuit connected at an upstream side of the decoder and the slave circuit connected at a downstream side of the decoder.

5. The semiconductor memory according to claim 4, wherein the sync read control circuit is arranged to increment the burst address in synchronization with the clock signal starting from a timing of the (N-1)th clock pulse where N being a predetermined number of clock pulses of the clock signal between a release of a burst mode start signal and the output of the output data.

6. The semiconductor memory according to claim 5, wherein
the composite circuit is arranged in which the burst address latched by the master circuit is decoded by the decoder and then latched by the slave circuit.

7. The semiconductor memory according to claim 6, wherein
the composite circuit has an output address switching function for releasing the burst address when it is at a burst read mode and directly releasing a lower address when it is at an asynchronous read mode.

8. An address control circuit provided in a semiconductor memory, wherein
the address control circuit is constructed as a composite circuit having a master circuit of a flip-flop connected at an upstream side of a decoder and a slave circuit of the flip-flop connected at a downstream side of the decoder, which is arranged responsive to a read switching signal, a clock signal, a synchronous address signal synchronized with the clock signal, and an asynchronous address signal received from the outside, and
when the read switching signal is at a synchronous read mode, the composite circuit selects the synchronous address signal, latches the synchronous address signal with the clock signal in the master circuit of the flip-flop, decodes the latched synchronous address signal with the decoder, and latches the decoded synchronous address signal with the clock signal in the slave circuit of the flip -flop, and alternatively when the read switching signal is at an asynchronous read mode, the flip-flop becomes conductive and the decoder decodes and releases the asynchronous address signal.

9. The address control circuit according to claim 8, wherein
the composite circuit is arranged for decoding the synchronous address signal latched by the master circuit with the decoder and latching the decoded synchronous address signal with the slave circuit.

10. The address control circuit according to claim 9, wherein
the composite circuit has an output address switching function of releasing the synchronous address signal when it is at the synchronous read mode and directly releasing the asynchronous address signal when it is at the asynchronous read mode.
